(19) United States
(12) Patent Application Publication
(10) Pub. No.: US 2016/0009018 A1
(43) Pub. Date: Jan. 14, 2016

(54) IN-MOLD LABEL FOR STRETCH BLOW MOLDING AND LABELED STRETCH BLOW MOLDED PRODUCT USING SAME

(71) Applicant: YUPO CORPORATION, Chiyoda-ku, Tokyo (JP)

(72) Inventors: Takashi FUNATO, Ibaraki (JP); Yuta IWASAWA, Ibaraki (JP)

(73) Assignee: YUPO CORPORATION, Chiyoda-ku, Tokyo (JP)

(21) Appl. No.: 14/771,375

(22) PCT Filed: Mar. 3, 2014
(86) PCT No.: PCT/CN2014/072772

§ 371 Date: Aug. 28, 2015

(30) Foreign Application Priority Data
Mar. 1, 2013 (CN) 201310065448.7
Apr. 9, 2013 (CN) 201310121582.4

(51) Int. Cl. B29C 49/24; C09J 7/02; B29C 49/10

(52) U.S. Cl. CPC B29C 49/24; B29C 49/10; C09J 7/0296; C09J 7/0242; B29C 2049/241; B29C 2049/2429; C09J 151/003

(57) ABSTRACT

Problem: To provide an in-mold label for stretch blow molding having excellent adhesiveness of the label particularly after molding of a molded product. Furthermore, to provide a labeled stretch blow molded product that uses the label.

Resolution Means: An in-mold label for stretch blow molding, the in-mold label comprising a substrate layer (I) and a heat sealable resin layer (II), the substrate layer (I) comprising a thermoplastic resin and an inorganic fine powder, the heat sealable resin layer (II) comprising a coating layer formed by applying a coating solution containing an ethylene-based copolymer on the substrate layer (I) and drying.

### TECHNICAL FIELD

The present invention relates to an in-mold label for stretch blow molding used in in-mold molding for producing a label-laminated molded product, in which a label is previously set in a mold such that the surface side on which printing of the label has been performed abuts on the mold wall surface, and a preform made of thermoplastic resin is introduced into the mold and stretch blow molded; and a stretch blow molded product to which the label is adhered.

### BACKGROUND

Conventionally, to integrally mold a labeled resin molded product, a blank or label is previously inserted in a mold, and then a resin molded product is molded inside the mold by a technique such as injection molding, blow molding, differential pressure molding, or foam molding, and the label is thereby adhered to the resin molded product for decoration or the like.

Known examples of this type of label include labels in which a film obtained by extrusion molding or calendar molding of crystalline polypropylene or polyethylene or the like is used as a substrate, and the substrate is coated by a gravure coater with a solution of low-melting-point olefin-based resin and dried; labels obtained by laminating on the above substrate using a low-melting-point olefin-based resin film as an adhesive; and labels obtained by extruding a low-melting-point olefin-based resin and directly laminating it on the above substrate by lamination (for example, see Patent Document 1 and Patent Document 2).

On the other hand, examples of blow molding techniques for molding a resin molded product in a mold include a technique by direct blow molding using a parison of resin, and a technique by stretch blow molding using a preform of resin.

In the former technique, resin is heated to not less than the melting point of the raw material resin, and with the resin in the molten state, a parison is formed and blown up with pressurized air; in the latter technique, a preform is heated to the softening point of the raw material resin, and in a state where the resin is deformable, the preform is stretched with a rod and further blown up with pressurized air.

Even when the same raw material resin is used, the amount of heat applied to the resin differs greatly between the two techniques due to the difference of whether it is put in a molten state or a softened state. For this reason, with the former label designed with direct blow molding in mind, a labeled molded product without problems in quality such as adhesion strength is obtained by sufficiently melt-activating low-melting-point resin by the quantity of heat applied to the label by the molten parison, whereas, when stretch blow molding is used, there are the problems that the preform does not provide a quantity of heat sufficient to melt-activate the low-melting-point resin of the label and the label cannot be adhered or readily peels due to a lack of adhesion strength of the label.

For this reason, in order to enable application to stretch blow molding having low molding temperature, there have been attempts to use a label in which a water-based heat sealable resin coating layer is provided on a substrate film that can quickly absorb liquid, in which the constitution of the substrate film and adhesive of the label have been changed (for example, see Patent Document 3), or a label in which a delayed adhesive requiring a low quantity of heat to melt is provided in resin used in the adhesive layer of the label (for example, see Patent Document 4).

However, as in Patent Document 3, it has been demonstrated that when the liquid absorption rate of the substrate is too fast (the liquid absorption coefficient is not less than 5 mL/m² (ms)^{1/2}), numerous coating irregularities caused by air bubbles in the coating film readily occur when the water-based heat sealable resin coating agent is applied to the substrate film, and in such cases, the desired adhesion strength cannot be stably obtained.

Furthermore, it has been demonstrated that when a delayed adhesive requiring a low quantity of heat to melt is used in the adhesive as in Patent Document 4, although sufficient adhesion strength is obtained, when low-molecular-weight components such as plasticizer contained in the adhesive bleed out from the adhesive layer and transfer to the surface of the label to be printed on when long label paper after being rolled up or label paper after being piled up are stored, they noticeably hinder transfer of the printing ink during subsequent printing.

### PRIOR ART DOCUMENT

### Patent Document

Patent Document 1: Japanese Unexamined Patent Application Publication No. S58-069015A
Patent Document 2: Japanese Unexamined Patent Application Publication No. H02-217223A
Patent Document 3: Japanese Unexamined Patent Application Publication No. 2004-255864A
Patent Document 4: Japanese Unexamined Patent Application Publication No. 2010-168117A

### SUMMARY OF THE INVENTION

### Problem to be Solved by the Invention

Thus, the present inventors conducted studies, with an object of the present invention being to provide a novelly developed in-mold label having sufficient adhesion strength with a molded product even under low-temperature adhesion conditions of stretch blow molding and having good transferability of printing ink during label printing. Another object of the present invention is to provide a labeled stretch blow molded product obtained using the label.

### Means to Solve the Problem

As a result of diligent research, the present inventors discovered that the anticipated objects could be achieved by performing in-mold molding using a label having a specified structure. Specifically, as means to solve the problem, they arrived at the present invention comprising the following configuration.

[1] An in-mold label for stretch blow molding, the in-mold label comprising a substrate layer (I) and a heat sealable resin layer (II), the substrate layer (I) comprising a resin composition containing a thermoplastic resin and an inorganic fine powder, the heat sealable resin layer (II) comprising a coating layer formed by applying a coating solution containing an ethylene-based copolymer on the substrate layer (I) and drying.

[2] The in-mold label for stretch blow molding according to [1], wherein a liquid absorption coefficient of a surface of the substrate layer (I) on a side of the heat sealable resin layer (II) is not greater than 4 mL/m² (ms)^{1/2}.

[3] The in-mold label for stretch blow molding according to [1] or [2], wherein the thermoplastic resin contains a polypropylene-based resin.

[4] The in-mold label for stretch blow molding according to any of [1] to [3], wherein the substrate layer (I) comprises a non-stretched film of a resin composition.

[5] The in-mold label for stretch blow molding according to any of [1] to [3], wherein the substrate layer (I) comprises a stretched film of a resin composition that is at least uniaxially stretched.

[6] The in-mold label for stretch blow molding according to [5], wherein the substrate layer (I) comprises a stretched film in which a resin composition containing a thermoplastic resin and a hydrophilically treated inorganic fine powder is at least uniaxially stretched.

[7] The in-mold label for stretch blow molding according to any of [1] to [6], wherein the ethylene-based copolymer is an ethylene-vinylacetate copolymer.

[8] The in-mold label for stretch blow molding according to [7], wherein the ethylene-vinylacetate copolymer is a maleic acid-modified ethylene-vinylacetate copolymer.

[9] The in-mold label for stretch blow molding according to any of [1] to [8], wherein the coating solution containing an ethylene-based copolymer comprises an emulsion in which an ethylene-based copolymer is dispersed in an aqueous medium.

[10] The in-mold label for stretch blow molding according to [9], wherein an average particle size of the emulsion of ethylene-based copolymer is from 0.01 to 3 μm.

[11] The in-mold label for stretch blow molding according to any of [6] to [10], wherein the heat sealable resin layer (II) is a coating layer formed by drying in a state in which some of the coating solution containing an ethylene-based copolymer is absorbed on the stretched film.

[12] The in-mold label for stretch blow molding according to any of [1] to [11], wherein a printable layer (III) is further provided on a surface of the substrate layer (I).

[13] An in-mold labeled stretch blow molded product to which the in-mold label for stretch blow molding described in any of [1] to [12] is adhered, an adhesion strength of the label on the molded product being from 100 to 1000 g/15 mm.

[14] The in-mold labeled stretch blow molded product according to [13], wherein the resin that forms the stretch blow molded product comprises at least one of polyester-based resins, polycarbonate-based resins, polystyrene-based resins, polypropylene-based resins, and polyethylene-based resins.

### Effect of the Invention

The present invention provides an in-mold label having sufficient adhesion strength with a molded product even under low-temperature adhesion conditions of stretch blow molding and having good transferability of printing ink during label printing. Furthermore, the present invention provides, using that label, a labeled stretch blow molded product in which adhesion strength with the label is high and the label and molded product look integrated.

### BRIEF DESCRIPTION OF THE DRAWINGS

FIG. 1 is a cross-sectional view of one aspect of the in-mold label for stretch blow molding of the present invention.

FIG. 2 is a cross-sectional view of another aspect of the in-mold label for stretch blow molding of the present invention.

FIG. 3 is a cross-sectional view of another aspect of the in-mold label for stretch blow molding of the present invention.

FIG. 4 is a cross-sectional view of another aspect of the in-mold label for stretch blow molding of the present invention.

FIG. 5 is a cross-sectional view of another aspect of the in-mold label for stretch blow molding of the present invention.

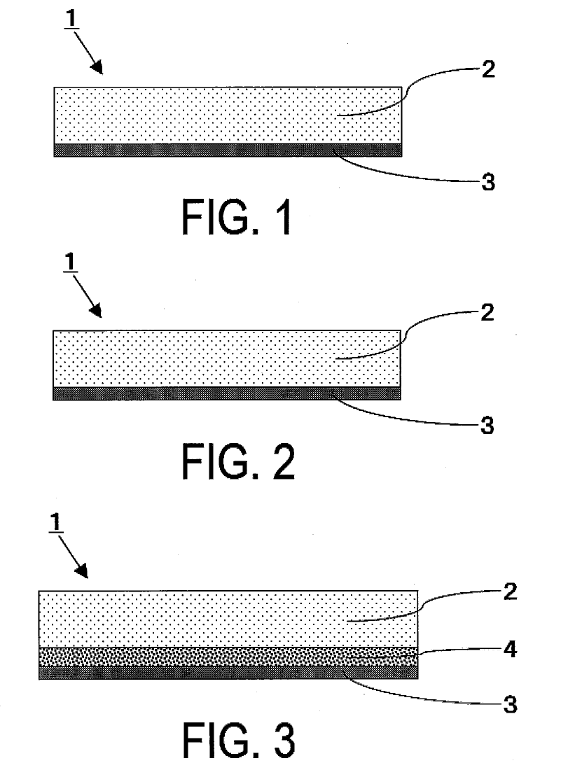

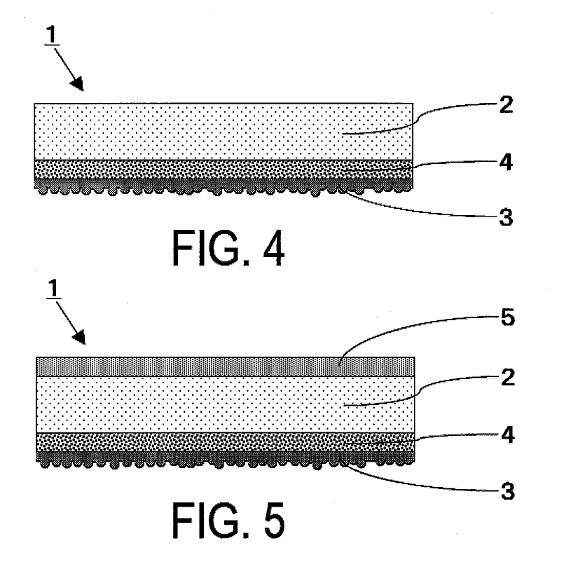

### BEST MODE FOR CARRYING OUT THE INVENTION

The in-mold label and molded product that uses it according to the present invention will be described in further detail below. The descriptions of constituent elements given below are based on typical embodiments of the present invention, but the present invention is not limited to such embodiments. In the present specification, the numeric ranges expressed using “to” indicate ranges that include the numeric values before and after the “to” as the lower and upper limit values, respectively.

### In-Mold Label

The in-mold label of the present invention has a laminate structure and comprises at least a substrate layer (I) and a heat sealable resin layer (II).

The substrate layer (I) comprises a resin composition comprising a thermoplastic resin and an inorganic fine powder, and the heat sealable resin layer (II) comprises a coating layer formed by applying a coating solution containing an ethylene-based copolymer on the substrate layer (I) and drying.

The in-mold label of the present invention preferably further has a printable layer (III) provided on the surface of the substrate layer (I).

### Substrate Layer (I)

The substrate layer (I) used in the in-mold label of the present invention serves as a support body of the in-mold label, and it confers enough rigidity to the label to allow handling such as printing on the label and insertion in the mold. On the other hand, the substrate layer (I) makes the in-mold label white and opaque, and specifically, comprises a resin composition containing a thermoplastic resin and an inorganic fine powder.

The substrate layer (I) is a resin film containing a thermoplastic resin. The thermoplastic resin used in the substrate layer (I) include films of olefin-based resins such as polypropylene-based resins, polymethyl-1-pentene, and ethylene-cyclic olefin copolymers, polyethylene terephthalate resins, polybutylene terephthalate resins, polyvinyl chloride resins, polyamide-based resins such as nylon-6, nylon-6,6, nylon-6,10, nylon-6,12 and the like; and polystyrenes, polycarbonates, and ionomer resins. A thermoplastic resin having a melting point in the range from 130 to 280° C., such as polypropylene-based resins and polyethylene terephthalate resins, is preferred. Two or more types of these resins may also be mixed.

The thermoplastic resin that constitutes the main component of the substrate layer (I) is preferably a resin having a melting point not less than 15° C. higher than the melting point of the ethylene-based copolymer that constitutes the heat sealable resin layer (II) to be described later. Among these resins, polypropylene-based resins are more preferred from the perspectives of transparency, heat resistance, durability, cost, and the like. Examples of such polypropylene-based resins that can be used include propylene homopolymers exhibiting isotactic or syndiotactic stereoregularity, or copolymers of primarily propylene with an α-olefin such as ethylene, butene-1, hexene-1, heptene-1, and 4-methylpentene-1. These copolymers may be bipolymers, terpolymers, or quaterpolymers, and may be random copolymers or block copolymers.

The substrate layer (I) also comprises an inorganic fine powder. The inorganic fine powder makes the substrate layer (I) white and opaque, and increases visibility of printing provided on the in-mold label.

The inorganic fine powder used normally has a particle size from 0.01 to 15 μm, and preferably from 0.01 to 5 μm. Specifically, calcium carbonate, calcined clay, silica, diatomaceous earth, kaolin, talc, titanium oxide, barium sulfate, alumina, zeolite, mica, sericite, bentonite, sepiolite, vermiculite, dolomite, wollastonite, glass fibers, and the like may be used.

The amount of inorganic fine powder added to the substrate layer (I) is preferably from 10 to 70% by weight of the total weight of the substrate layer (I), more preferably from 20 to 60% by weight, and even more preferably from 30 to 50% by weight.

Furthermore, these inorganic fine powders that have been hydrophilically treated on the surface may also be used. By implementing surface hydrophilic treatment on these inorganic fine powders and by making the substrate layer (I) porous by stretching to be described later, the characteristic of absorbing liquid can be conferred to the substrate layer (I) as shown in Japanese Unexamined Patent Application Publication No. 2001-226507A.

The surface treatment agent is preferably at least one of a water-soluble cationic copolymer and a water-soluble anionic surfactant. Here, the water-soluble cationic copolymer used as the surface treatment agent is preferably a copolymer of (1) at least one of a diallyl amine salt and an alkyl diallyl amine salt and (2) a nonionic hydrophilic vinyl monomer.

Specific examples of diallyl amine salts and alkyl diallyl amine salts of (1) include diallyl amine salts, and alkyl diallyl amine salts and dialkyl diallyl amine salts having from 1 to 4 carbons, specifically, methyl diallyl amine salts, ethyl diallyl amine salts, and dimethyl diallyl amine salts; chlorides, bromides, methosulfates, and ethosulfates of methacryloyloxy ethyl trimethylammonium, acryloyloxy ethyl trimethylammonium, methacryloyloxy ethyl dimethylethylammonium, and acryloyloxy ethyl dimethylethylammonium; and quaternary ammonium salts obtained by alkylating N,N-dimethylamino ethyl methacrylate or N,N-dimethylamino ethyl acrylate with an epoxy compound such as epichlorohydrin, glycidol, or glycidyltrimethylammonium chloride. Among these, diallyl amine salts, methyl diallyl amine salts, and dimethyl diallyl amine salts are preferred.

Examples of anions that form the diallyl amine salts and alkyl diallyl amine salts of (1) include chloride ions, bromide ions, sulfate ions, nitrate ions, methylsulfate ions, ethylsulfate ions, methanesulfonate ions, and the like.

Specific examples of nonionic hydrophilic vinyl monomer of (2) include acrylamide, methacrylamide, N-vinylformamide, N-vinylacetamide, N-vinylpyrrolidone, 2-hydroxyethyl methacrylate, 2-hydroxyethyl acrylate, 2-hydroxypropyl(meth)acrylate, 3-hydroxypropyl(meth)acrylate, methyl(meth)acrylate ester, ethyl(meth)acrylate ester, and butyl(meth)acrylate ester, among which acrylamide and methacrylamide are preferred.

The copolymerization ratio of (1) and (2) may be any, but (1) is preferably from 10 to 99 mol %, more preferably from 50 to 97 mol %, and even more preferably from 65 to 95 mol %, while (2) is preferably from 90 to 1 mol %, more preferably from 50 to 3 mol %, and even more preferably from 35 to 3 mol %.

On the other hand, the water-soluble anionic surfactant that can be used as the surface treatment agent has an anionic functional group in the molecule. Specific examples of the water-soluble anionic surfactant include sulfonates having a hydrocarbon group having from 4 to 40 carbons, phosphoric acid ester salts having a hydrocarbon group having from 4 to 40 carbons, phosphoric acid mono- or diester salts of higher alcohols having from 4 to 40 carbons, alkyl betaines or alkyl sulfobetaines having a hydrocarbon group having from 4 to 40 carbons, and the like, which may be selected as appropriate.

The substrate layer (I) may also use additives such as antioxidants, lightstabilizers, dispersants, lubricants, and antistatic agents as necessary.

When an antioxidant is used, specifically, an antioxidant that is sterically hindered phenol-based, phosphorus-based, amine-based, sulfur-based, or the like is added in a range normally from 0.001 to 1% by weight. When a lightstabilizer is used, specifically, a sterically hindered amine-based, benzotriazole-based, or benzophenone-based lightstabilizer is added in a range normally from 0.001 to 1% by weight.

The thickness of the substrate layer (I) is in the range from 20 to 200 μm, and preferably from 40 to 150 μm. When the thickness is not less than 20 μm, wrinkling of the label does not readily occur during printing, and the problem of it not being fixed and deviating from the proper position during insertion in the mold does not readily occur. When the thickness is not greater than 200 μm, problems such as decreased drop-resistant strength accompanying decreased strength of the outline portion between the obtained label and the labeled molded product do not readily occur.

### Heat Sealable Resin Layer (II)

The heat sealable resin layer (II) used in the in-mold label of the present invention comprises a coating layer formed by applying a coating solution containing an ethylene-based copolymer on the substrate layer (I) and drying. The heat sealable resin layer (II) confers sufficient adhesion strength with the molded product even under low-temperature adhesion conditions in stretch blow molding.

### Ethylene-Based Copolymer

The ethylene-based copolymer contained in the heat sealable resin layer (II) is a copolymer obtained from a polymerization reaction of ethylene with another comonomer. In the present invention, examples of the another comonomer include vinyl acetate, acrylic acid, methacrylic acid, acrylic acid alkyl esters (the alkyl group preferably having from 1 to 8 carbons), methacrylic acid alkyl esters (the alkyl group preferably having from 1 to 8 carbons), maleic anhydride, and the like.

Specific examples of the ethylene-based copolymer include ethylene-vinylacetate copolymers, ethylene-acrylic acid copolymers, ethylene-methacrylic acid copolymers, metal salts of ethylene-methacrylic acid copolymers, ethylene-methacrylic acid-acrylic acid alkyl ester copolymers, ethylene-acrylate alkyl ester-maleic anhydride copolymers, and carboxylic acid-modified substances obtained by modifying these copolymers with carboxylic acid.

Examples of the metal that constitutes the above metal salt include zinc (Zn), aluminum (Al), lithium (Li), sodium (Na), potassium (K), and the like. Examples of carboxylic acid-modified substances include maleic acid-modified substances and the like.

Preferred ethylene-based copolymers among the above copolymers are a copolymer containing ethylene and at least one of vinyl acetate, acrylic acid, and methacrylic acid as a comonomer. In this case, a labeled stretch blow molded product having more excellent adhesion strength between the label and molded product is obtained even in molding techniques that require adhesion at relatively low temperatures (for example, the preform temperature is from 90 to 110° C., and preferably from 95 to 110° C.), as in stretch blow molding.

Preferred specific examples of such an ethylene-based copolymer include ethylene-vinylacetate copolymers (sometimes called EVA), maleic acid-modified ethylene-vinylacetate copolymers, ethylene-methacrylic acid copolymers (sometimes called EMA), and ethylene-methacrylic acid-acrylic acid alkyl ester copolymers.

Among these copolymers, those containing at least one of ethylene-vinylacetate copolymers and carboxylic acid-modified ethylene-vinylacetate copolymers are preferred because adhesion strength between the label and blow molded product is even better even under low-temperature adhesion conditions.

The ethylene-vinylacetate copolymer preferably has a melt flow rate not less than 20 g/10 min. If the melt flow rate of the copolymer is not less than 20 g/10 min, when melted and activated, the area that contacts the stretch blow molded product can be increased due to its fluidity, and the adhesion strength between the label and blow molded product tends to be even better.

The content of vinylacetate in the ethylene-vinylacetate copolymer is preferably from 5 to 50% by weight relative to the total amount of the copolymer (100% by weight). When the vinylacetate content in the copolymer is not less than 5% by weight, it tends to have high adhesiveness to the stretch blow molded product. It is also easy to dissolve in media, and production of a carboxylic acid-modified substance to be described below is easy. On the other hand, when the vinylacetate content in the copolymer is not greater than 50% by weight, high adhesiveness tends to be obtained even when an olefin-based resin is used to form the substrate layer (I) described above or the stretch blow molded product to be described later.

The acid value of the carboxylic acid-modified ethylene-vinylacetate copolymer is preferably in the range from 1 to 60. When the acid value is not less than 1, an aqueous dispersion is readily obtained. On the other hand, when the acid value is not greater than 60, water resistance and moisture resistance are readily increased.

Additionally, as such a copolymer, it is further preferred to use a carboxylic acid-modified ethylene-vinylacetate copolymer that has been modified with carboxylic acid to improve the adhesion and water dispersibility thereof.

The carboxylic acid-modified ethylene-vinylacetate copolymer may be produced by a known method. For example, as described in Japanese Unexamined Patent Application Publication No. H3-112836A, a carboxylic acid-modified ethylene-vinylacetate copolymer may be obtained by dissolving an ethylene-vinylacetate copolymer in an aromatic hydrocarbon such as toluene or xylene, adding a lower alcohol such as methyl alcohol or ethyl alcohol, performing a saponification reaction using an alkali alcoholate catalyst in the presence of a specified amount of water, and then reacting the obtained saponified product of ethylene-vinylacetate copolymer with a radical initiator and at least one among unsaturated carboxylic acids (for example, maleic acid, fumaric acid, itaconic acid, citraconic acid, allyl succinic acid, mesaconic acid, aconitic acid), and acid anhydrides thereof, and acid esters thereof.

Most preferred among these is a maleic acid-modified ethylene-vinylacetate copolymer obtained by reaction with at least one of maleic acid and maleic anhydride.

One type of the above copolymers and acid-modified copolymers may be used alone, or two or more types may be mixed.

It is preferred that secondary components of low molecular weight not be blended with these copolymers from the perspective of avoiding hindrance of the adhesiveness thereof and label printability. However, for the purpose of using these copolymers in the state of an aqueous dispersion or emulsion to be described later, dispersants and the like may be blended as necessary to the extent that adhesiveness and label printability are not diminished. Additionally, so-called tackifiers such as rosin and derivatives thereof, terpene and derivatives thereof, petroleum resins, and hydrogenated products thereof, waxes such as paraffin wax, microcrystalline wax, carnauba wax, and Fischer-Tropsch wax, inorganic fine powder-based antiblocking agents such as silica, talc, and zeolite, organic-based slip agents such as amide erucate, amide oleate and amide stearate, and, as components to improve cohesive force and adhesive force, thermoplastic polyurethanes, thermoplastic polyesters, polypropylene chlorides, polyethylene chlorides, and the like may be blended as necessary.

The coating solution containing an ethylene-based copolymer may be used as a solution in which these copolymers are dissolved in an organic solvent, or in a state of an emulsion in which these copolymers are dispersed in an aqueous solvent.

An in-mold label that uses an ethylene-based copolymer emulsion is opaque due to the emulsion particles, and has an advantage of easy identification of any defects during the printing. Thus, in the in-mold labeled stretch blow molded product to which this is adhered, the label and molded product look integrated without differences in appearance since the emulsion particles disappear due to melting of the ethylene-based copolymer and the heat sealable resin layer (II) becomes transparent.

As a method for obtaining an aqueous emulsion in which these copolymers are dispersed in water, as described in, for example, Japanese Unexamined Patent Application Publication Nos. S58-118843A, S56-2149A, S56-106940A, S56-157445A, they are obtained by supplying copolymer resin to a twin-screw extruder, and after melt-kneading, introducing water containing a dispersant from a liquid introduction pipe provided in the compressor region or vent region of the extruder, and by rotating the screws, kneading the melted copolymer resin and the water, causing a phase transition of the kneaded matter in the housing of the extruder, discharging the mixture to the air pressure region from the outlet nozzle of the extruder, adding water as necessary, and housing it in a storage tank.

The average dispersion particle size of the copolymer resin particles in the emulsion is from 0.01 to 3 μm, and preferably from 0.1 to 1 μm. When the average dispersion particle size of the copolymer resin particles is within this range, the phases are stable in the dispersion, and the liquid has excellent storability and coatability. Furthermore, the transparency of the heat sealable resin layer (II) formed by applying this dispersion after the resin layer is adhered to the blow molded product also tends to be high.

The solid concentration is preferably from 8 to 60% by weight, and more preferably from 20 to 50% by weight. When the solid concentration due to the copolymer resin particles in the emulsion is within this range, the phases are stable in the dispersion, and the liquid has excellent storability and coatability. Examples of such ethylene-based copolymer emulsions that can be used include the commercially available products LIFE BOND HC-12, HC-17, HC-38, and HCN-006 (trade names, produced by Nichiei Kako Co., Ltd.); AD-37P295J and EA-H700 (trade names, produced by Toyo-Morton, Ltd.); and Aquatex EC-1200, EC-1700, EC-1800, EC-3500, and AC-3100 (trade names, produced by Chuo Rika Kogyo Corp.). Furthermore, examples of coating solutions in which an ethylene-based copolymer is dissolved in an organic solvent that can be used include the commercially available products THS-4884 and AD-1790-15 (trade names, produced by Toyo-Morton, Ltd.), and the like.

### Coating

As a method for coating the substrate layer (I) with the coating solution containing an olefin-based resin, a coating apparatus such as a gravure coater, microgravure coater, reverse coater, blade coater, meyer bar coater, air knife coater, or the like may be used.

After coating, the coating layer is dried to remove the solvent (primarily water), and the produced coating film constitutes the heat sealable resin layer (II). The film thickness of the heat sealable resin layer (II) is preferably from 0.3 to 10 and more preferably from 1 to 5 μm. When the film thickness is not less than 0.3 μm, the molded product and the label tightly fuse together and high adhesion strength is readily obtained. When the film thickness is less than 10 μm, drying after coating is easy, and reduced transparency and reduced adhesion strength due to insufficient cohesive force are not seen, which is desirable.

### Printable Layer (III)

In the in-mold label of the present invention, a printable layer (III) may be further provided on the surface of the substrate layer (I) to serve as the outermost layer of the label. The printable layer (III) is provided for the purpose of increasing suitability for printing of the in-mold label.

Examples of the material of the printable layer (III) include films of polyolefin-based resins such as polypropylene-based resins, high-density polyethylenes, medium-density polyethylenes, straight-chain low-density polyethylenes, ethylene-vinylacetate copolymers, ethylene-acrylic acid copolymers, ethylene-acrylic acid alkyl ester copolymers, ethylene-methacrylic acid alkyl ester copolymers (the alkyl group preferably having from 1 to 8 carbons), metal salts (Zn, Al, Li, K, Na, and the like) of ethylene-methacrylic acid copolymers, poly 4-methyl-1-pentene, and ethylene-cyclic olefin copolymers, polyethylene terephthalate resins, polyvinyl chloride resins, polyamide-based resins such as, nylon-6, nylon-6,6, nylon-6,10, and nylon-6,12, ABS resins, and ionomer resins. A thermoplastic resin having a melting point in the range from 130 to 280° C., such as polypropylene-based resins, high-density polyethylenes, and polyethylene terephthalate resins, is preferred, and two or more of these resins may be used in a mixture.

Among these, the use of polyolefin-based resins is preferred. Furthermore, among polyolefin-based resins, polypropylene-based resins and high-density polyethylenes are preferred from the perspectives of cost, water resistance, and chemical resistance. As such polypropylene-based resins, propylene homopolymers exhibiting isotactic or syndiotactic or various degrees of stereoregularity, or copolymers of primarily propylene with an α-olefin such as ethylene, 1-butene, 1-hexene, 1-heptene, and 4-methyl-1-pentene are preferably used. These copolymers may be bipolymers, terpolymers, or quaterpolymers, and may be random copolymers or block copolymers.

Also, to improve ink adhesiveness, it preferably contains a thermoplastic resin having a polar group, such as an ethylene-vinylacetate copolymer, ethylene-acrylic acid copolymer, ethylene-acrylic acid alkyl ester copolymer, ionomer, ethylene-methacrylic acid alkyl ester copolymer (the alkyl group preferably having from 1 to 8 carbons), metal salt (Zn, Al, Li, K, Na, and the like) of an ethylene-methacrylic acid copolymer, maleic acid-modified polypropylene, maleic acid-modified polyethylene, or maleic acid-modified ethylene-vinylacetate copolymer. Among these, maleic acid-modified ethylene-vinylacetate copolymers, which have excellent ink adhesiveness, are preferred. Antioxidants, UV stabilizers, and the like may be added as necessary.

The thickness of the printable layer (III) is in the range from 1 to 30 μm, and preferably from 5 to 20 μm. When the thickness is not less than 1 μm, ink adhesiveness is improved, and when it is not greater than 30 μm, curling of the label does not readily occur. Therefore, offset printing on the label and affixing of the label to the mold are not difficult, which are desirable.

In the in-mold label of the present invention, printability of the surface of the printable layer (III) can be improved by activation treatment as necessary. Activation treatment is at least one oxidation treatment method selected from corona discharge treatment, flame treatment, plasma treatment, glow discharge treatment, and ozone treatment, and is preferably corona treatment or flame treatment. In corona treatment, the treatment dose is normally from 600 to 12,000 J/m² (from 10 to 200 W·min/m²), and preferably from 1200 to 9000 J/m² (from 20 to 150 W·min/m²). When the treatment dose is not less than 600 J/m² (10 W·min/m²), the effect of corona discharge treatment can be sufficiently obtained, and adhesiveness of ink is improved. Furthermore, when the treatment dose exceeds 12,000 J/m² (200 W·min/m²), the effect of the treatment reaches a plateau, and therefore the treatment dose of not greater than 12,000 J/m² (200 W·min/m²) is sufficient. In flame treatment, the treatment dose is normally from 8,000 to 200,000 J/m², and preferably from 20,000 to 100,000 J/m². When the treatment dose is not less than 8000 J/m², the effect of flame treatment can be sufficiently obtained, and adhesiveness of ink is improved. Furthermore, when the treatment dose exceeds 200,000 J/m², the effect of the treatment reaches a plateau, and therefore the treatment dose of not greater than 200,000 J/m² is sufficient.

The substrate layer (I) in the present invention is a porous film obtained through a stretching process to be described later, and if the substrate layer (I) has been provided with the characteristic of absorbing liquid, when the above coating solution containing an ethylene-based copolymer is applied to the substrate layer (I), it is applied in a state where some of the coating solution containing an ethylene-based copolymer has been absorbed in the substrate layer (I), and by drying and solidifying the coating solution in this state, the heat sealable resin layer (II) is formed on the surface of the substrate layer (I). When the heat sealable resin layer (II) is formed in a state in which the heat sealable resin layer (II) penetrates into the substrate layer (I), adhesion between the substrate layer (I) and the heat sealable resin layer (II) is extremely tight, and as a result, the adhesion strength between the label and the blow molded product tends to be even more excellent.

In this case, the capacity of the substrate layer (I) to absorb liquid can be adjusted by the absorption volume and the absorption rate. When the volume of liquid absorbed by the substrate layer (I) is too large, there is the possibility that nearly all of the applied coating solution will end up being stored in the substrate layer (I), and there is the risk that adhesiveness cannot be sufficiently achieved. The volume of liquid absorbed by the substrate layer (I) can be varied by varying the thickness of the substrate layer (I) and the pore volume in the substrate layer (I). Furthermore, when the rate of liquid absorption by the substrate layer (I) is too high, the solvent component of the coating solution containing an ethylene-based copolymer applied thereto will be rapidly absorbed in the substrate layer (I) and drying will be fast. However, rapid drying in the coating process causes a loss of levelness (uniformity) of the coating film, and bubbling in the coating film also readily occurs, leading to the risk that the desired adhesion strength will not be obtained. The rate of liquid absorption by the substrate layer (I) may be varied by varying the quantity of hydrophilic treatment of the used inorganic fine powder or the pore volume in the substrate layer (I).

The liquid absorption volume in the substrate layer (I) is preferably not greater than 100 mL/m², more preferably not greater than 50 mL/m², and even more preferably not greater than 10 mL/m² as liquid transfer volume V (mL/m²) according to the liquid absorbency test method (Bristow's method) of Japan TAPPI No. 51. On the other hand, the liquid absorption volume is preferably not less than 0.5 mL/m², more preferably not less than 3 mL/m², and even more preferably not less than 5 mL/m².

Additionally, the liquid absorption rate in the substrate layer (I) is preferably not greater than 4 mL/m² (ms)^{1/2}, more preferably not greater than 3.5 mL/m² (ms)^{1/2}, and even more preferably not greater than 3 mL/m² (ms)^{1/2} as liquid absorption coefficient Kα (mL/m² (ms)^{1/2}) according to the liquid absorption rate test method (Bristow's method) of Japan TAPPI No. 51. On the other hand, the liquid absorption rate is preferably not less than 0.5 mL/m² (ms)^{1/2}, more preferably not less than 1 mL/m² (ms)^{1/2}, and even more preferably not less than 1.5 mL/m² (ms)^{1/2}.

Printing on the printable layer (III) of the label of the present invention may be carried out by a printing method such as letter printing, gravure printing, offset printing, flexo printing, or screen printing. On the label, for example, a bar code, manufacturer, dealer, characters, brand name, method of use, and the like may be printed. The printed label is separated into labels of the required shape and dimensions by punching. This in-mold label may be a partial label adhered to part of a molded product surface, but normally it may be used as a blank that wraps around the side of a container-like molded product, or as labels respectively adhered to the front side and/or rear side of a container-like molded product.

### Molding of Substrate Layer (I) and Printable Layer (III)

The substrate layer (I) and printable layer (III) that constitute the in-mold label of the present invention may be produced by various methods known to persons skilled in the art or combinations thereof. An in-mold label produced by any sort of method is encompassed within the scope of the present invention as long as it satisfies the conditions described in the present invention.

Examples of the method for forming the substrate layer (I) in the present invention include a cast forming method in which molten resin is extruded into sheet form using a single-layer T-die connected to a screw extruder, an inflation forming method in which molten resin is extruded in tube form using an O-die connected to a screw extruder, a rolling method, a calendar forming method, and the like.

The substrate layer (I) itself may be a single-layer structure or a multilayer structure of two layers or more. Multilayering of the substrate layer (I) enables addition of functions such as, for example, improving gas barrier characteristics.

### Multilayering

The substrate layer (I) in the present invention may be a single-layer resin film, but it may also be a laminate resin film in which a printable layer (III) is laminated on the substrate layer (I).

Therefore, the in-mold label of the present invention may employ a laminate structure containing the substrate layer (I)/heat sealable resin layer (II), or the printable layer (III)/substrate layer (I)/heat sealable resin layer (II).

The substrate layer (I) and printable layer (III) may be premolded as a laminate resin film. The in-mold label of the present invention is then obtained by providing the heat sealable resin layer (II) by the above-described coating method on the surface of the obtained laminate resin film on the substrate layer (I) side.

These laminate resin films may be produced by various known film production techniques or combinations thereof. Examples include coextrusion methods that use a multilayer T-die connected to screw extruders, extrusion lamination methods that use a plurality of dies, melt lamination methods, hot lamination methods, dry lamination methods and wet lamination methods that use various adhesives, and the like. A combination of a multilayer die and extrusion lamination may also be used. Coextrusion methods are preferred from the perspective of enabling tight adhesion of the layers.

### Stretching

The substrate layer (I) and printable layer (III) that constitute the in-mold label of the present invention may be non-stretched or unstretched that is not stretched, or may be at least uniaxially stretched. When unstretched, transparency is more superior and shape conformance to the stretch blow molded product is superior. When stretched, transparency is superior due to reduced film thickness and it is light-weight and has superior uniformity in thickness.

These layers may be stretched by various known methods or combinations thereof. Examples include machine-direction stretching utilizing the circumferential speed differential of a group of rollers, transverse-direction stretching using a tenter oven, sequential biaxial stretching which combines machine-direction stretching and transverse-direction stretching, simultaneous biaxial stretching by a combination of a tenter oven and a linear motor, simultaneous biaxial stretching by a combination of a tenter oven and a pantograph, rolling, and the like. Furthermore, when inflation molding is used, simultaneous biaxial stretching by adjusting the blown air volume may be employed.

The stretching ratio is not particularly limited, and is determined as appropriate in consideration of the characteristics of the thermoplastic resin primarily used in the substrate layer (I) serving as a support body, the characteristics of the obtained laminate resin film, and the like. For example, when propylene homopolymer or a copolymer thereof is used as the thermoplastic resin of the substrate layer (I), when stretched in one direction, the stretching ratio is normally from 1.2 to 12 times, and preferably from 2 to 10 times, and when stretched biaxially, the area ratio is normally from 1.5 to 60 times, and preferably from 4 to 50 times. When another thermoplastic resin is used, when stretched in one direction, the stretching ratio is normally from 1.2 to 10 times, and preferably from 2 to 5 times, and when stretched biaxially, the area ratio is normally from 1.5 to 20 times, and preferably from 4 to 12 times.

The temperature of stretching is determined as appropriate within a known temperature range favorable for thermoplastic resins, from not less than the glass transition temperature of the thermoplastic resin primarily used in the substrate layer (I) to not greater than the melting point of the crystal portion. Specifically, when the thermoplastic resin of the substrate layer (I) is a propylene homopolymer (melting point from 155 to 167° C.), it is from 100 to 166° C., which is from 1 to 70° C. lower than the melting point. Furthermore, the stretching rate is preferably from 20 to 350 m/min.

Therefore, the substrate layer (I) of the present invention is more preferably a non-stretched film (CPP film) or a stretched film (OPP film) of polypropylene-based resin containing an inorganic fine powder. When the substrate layer (I) is a non-stretched film, crystallization accompanying stretching orientation of the polypropylene-based resin molecules is suppressed, and flexibility that enables conformance to shape changes of the molded product during blow molding is readily obtained. When the substrate layer (I) is a stretched film, the substrate layer may be so-called pearl film or synthetic paper. Higher opacity is readily obtained from these substrates.

### In-Mold Molding

The in-mold label of the present invention can be advantageously used as an in-mold label for blow molding (for stretch blow molding) in which a heated resin preform is pressed against the inner wall of the mold by a rod and pressurized air. In the stretch blow molded product produced using the in-mold label of the present invention, there is little difference in appearance between the portion where the label is adhered and the portion where no label is adhered, which gives the product a more highly integrated look.

Examples of the resin that forms the stretch blow molded product include polyester-based resins such as polyethylene terephthalate, polybutylene terephthalate, polybutylene succinate, and polylactic acid, polycarbonate-based resins, styrene-based resins such as polystyrene, styrene-acrylonitrile copolymers, and styrene-butadiene copolymers, polypropylene-based resins, polyethylene-based resins, and the like.

These resins may be transparent and of natural color not containing any pigments, dyes, or the like, but they may also be opaque colored resins containing pigments, dyes, or the like.

### EXAMPLES

The present invention will be described more specifically below while citing production examples, working examples, and test examples. The materials, used amounts, proportions, treatment contents, treatment procedures, and the like described in the examples below may be varied as appropriate provided that they do not deviate from the spirit of the present invention. Therefore, the technical scope of the present invention is not limited by the specific examples given below.

Note that measurement and evaluation of physical properties in the production examples, working examples, and comparative examples were performed by the methods described below.

### Production Example of Substrate Layer (I)

### Production Example 1

A mixture (a) of 95% by weight of propylene homopolymer (trade name Novatec PP MA3, produced by Japan Polypropylene Corp.) and 5% by weight of titanium dioxide fine powder (trade name Tipaque CR-60, produced by Ishihara Sangyo Kaisha, Ltd.) as the resin composition for the substrate layer (I), a mixture (b) of 85.7% by weight of ethylene-hexene-1 copolymer (trade name Kernel KS340T, produced by Japan Polyethylene Corp.), 9.5% by weight of high-pressure low-density polyethylene (trade name Novatec LD LC720, produced by Japan Polyethylene Corp.), and 4.8% by weight of antistatic agent (trade name Novatec LL LX-AS, produced by Japan Polyethylene Corp.), and a mixture (c) of 70% by weight of propylene homopolymer (trade name Novatec PP MA3U, produced by Japan Polypropylene Corp.) and 30% by weight of high-pressure low-density polyethylene (trade name Novatec LD LC720, produced by Japan Polyethylene Corp.) as the resin composition for the printable layer (III) were each melt-kneaded at 240° C. using respective extruders. They were supplied to one coextrusion T-die and laminated in three layers inside the T-die, and then extruded in sheet form from the T-die. This was guided between semi-mirror-tone cooling rollers and matte-tone rubber rollers and cooled while being compressed (linear pressure: approximately 1.5 kg/cm), to produce a white opaque non-stretched laminate resin film having a three-layer structure of (c/a/b).

This was then guided into a corona discharge treatment device by guide rollers, and corona discharge treatment was performed in a treatment dose of 50 W·min/m² on the surface of the printable layer (III) side, and after the edge of the film was cut off, it was wound up by a winder.

The semi-mirror-tone cooling rollers that were used were mirror finish metal cooling rollers plated with a hardened chrome, which is processed to a semi-mirror tone and then polished, and has surface roughness (arithmetic mean roughness Ra according to JIS B-0601) of 0.3 μm, maximum height of the profile (Ry) of 2.9 μm, ten point height of irregularities (Rz) of 2.2 μm, diameter of 450 mm, width of 1500 mm, and a cooling temperature of 70° C.

The matte-tone rubber rollers that were used had rubber hardness measured using a spring-type JIS hardness gauge (according to JIS K-6301:1995) of 70 Hs, contained from 20 to 55% by weight of fine particles of silica glass or silica sand of particle size from 31 to 37 μm, and had a diameter of 300 mm and width of 1500 mm.

During compression, the semi-mirror-tone cooling rollers were in contact with mixture (b) and the matte-tone rubber rollers were in contact with mixture (c). The obtained laminate resin film had a thickness of 100 μm and a density of 0.89 g/cm³.

### Production Example 2

A mixture (d) of 70% by weight of propylene homopolymer (trade name Novatec PP FY4, produced by Japan Polypropylene Corp.), 10% by weight of high-density polyethylene (trade name Novatec HD HJ360, produced by Japan Polyethylene Corp.), and 20% by weight of calcium carbonate fine powder (trade name Softon 1800, produced by Bihoku Funka Kogyo Co., Ltd.) as the resin composition of the substrate layer (I), and a mixture (e) of 70% by weight of propylene homopolymer (trade name Novatec PP MA3, produced by Japan Polypropylene Corp.) and 30% by weight of calcium carbonate fine powder (trade name Softon 1800, produced by Bihoku Funka Kogyo Co., Ltd.) were each melt-kneaded in respective extruders set at 230° C. They were then supplied to one coextrusion T-die set at 250° C. and laminated inside the T-die, and then extruded in sheet form. This was cooled by a cooling apparatus to produce a non-stretched sheet having a three-layer structure of (e/d/e). This non-stretched sheet was stretched five-fold in the machine-direction while heating at 150° C. Then, after it was cooled to 60° C., it was again heated to 150° C. and stretched eight-fold in the transverse-direction by a tenter. It was annealed at 160° C. and then cooled to 60° C., to produce a white opaque biaxially stretched laminate resin film having a three-layer structure of (e/d/e).

This was then guided into a corona discharge treatment device by guide rollers, and corona discharge treatment was performed in a treatment dose of 50 W·min/m² on the surfaces on both sides, and after the edge of the film was cut off, it was wound up by a winder.

The obtained laminate resin film had a thickness of 80 μm (e/d/e=10/60/10 μm) and a density of 0.76 g/cm³.

### Production Example 3

A mixture (f) of 75% by weight of propylene homopolymer (trade name Novatec PP FY6H, produced by Japan Polypropylene Corp.), 5% by weight of high-density polyethylene (trade name Novatec HD HJ580N, produced by Japan Polyethylene Corp.), and 20% by weight of calcium carbonate fine powder (trade name Softon 1800, produced by Bihoku Funka Kogyo Co., Ltd.) as the resin composition of the substrate layer (I) was melt-kneaded at 250° C. using an extruder. It was then supplied to an extrusion T-die and extruded in sheet form. This was cooled by a cooling apparatus to produce a non-stretched sheet having a single-layer structure of (f).

Then, this non-stretched sheet was heated to 145° C. and stretched 4.5-fold in the machine-direction utilizing the circumferential speed differential of a group of rollers, to produce a stretched sheet.

On the other hand, a mixture (g) of 38% by weight of propylene homopolymer (trade name Novatec PP MA1B, produced by Japan Polypropylene Corp.), 2% by weight of maleic acid-modified polypropylene (trade name Yumex 1001, produced by Sanyo Chemical Industries, Ltd.), and 60% by weight of heavy calcium carbonate fine powder of which the surface was hydrophilically treated (trade name AFF-Z, produced by Fimatec Ltd.) as the resin composition of the substrate layer (I), and a mixture (h) of 55% by weight of propylene homopolymer (trade name Novatec PP MA3, produced by Japan Polypropylene Corp.) and 45% by weight of calcium carbonate fine powder (trade name Softon 1800, produced by Bihoku Funka Kogyo Co., Ltd.) were each melt-kneaded at 240° C. using respective extruders. They were then supplied to separate extrusion T-dies, and extruded into sheet forms and laminated on the two surfaces of the above-described stretched sheet. This was cooled by a cooling apparatus to produce a laminate sheet having a three-layer structure of (g/f/h).

Then, this laminate sheet was heated to 154° C. and stretched 8.5-fold in the transverse-direction using a tenter. It was annealed at 155° C. and then cooled to 55° C., to produce a white opaque stretched laminate resin film having a three-layer structure of (g/f/h).

This was then guided into a corona discharge treatment device by guide rollers, and corona discharge treatment was performed in a treatment dose of 50 W·min/m² on the surfaces on both sides, and after the edge of the film was cut off, it was wound up by a winder.

The obtained laminate resin film had a thickness of 95 μm (g/f/h=10/75/10 μm) and density of 0.81 g/cm³, and the number of stretch axes of each layer was one axis for layer (g), two axes for layer (f), and one axis for layer (h).

### Production Example 4

A biaxially stretched film of white opaque polyester (trade name Crisper G2311, produced by TOYOBO Co., Ltd.) having voids inside were obtained, and this was used as a laminate resin film.

This was then guided into a corona discharge treatment device, and corona discharge treatment was performed in a treatment dose of 50 W·min/m² on the surface of the untreated side, and it was wound up by a winder.

The obtained laminate resin film had a thickness of 38 μm and a density of 1.1 g/cm³.

### Production Example of in-Mold Label and Labeled Blow Molded Product

### Working Example 1

An emulsion solution of maleic acid-modified ethylene-vinylacetate copolymer (trade name EA-H700, produced by Toyo-Morton, Ltd.; solid concentration 50%) was applied using a microgravure coater to the surface on the (b) layer side of the laminate resin film obtained in Production Example 1, and it was dried in an oven set to 95° C. to provide a heat sealable resin layer (II), and an in-mold label for stretch blow molding of Working Example 1 was obtained. The film thickness of the obtained heat sealable resin layer (II) was 3 μm.

Then, the in-mold labels obtained in the working examples and comparative examples were punched into rectangles measuring 8 cm on the long edge by 6 cm on the short edge, they were charged using an electrostatic charger, and placed in a molding die of a stretch blow molder (trade name ASB-70DPH, produced by Nissei ASB Machine Co., Ltd.) such that the printable layer (III) abutted on the mold (such that the heat sealable resin layer (II) faced toward the cavity side). The labels were placed in the mold such that the long edge of the label would adhere parallel to the circumferential direction of the body of the molded product. The mold was cooled such that the surface temperature on the cavity side was in the range from 20 to 45° C.

Then, a polyethylene terephthalate preform of natural color was preheated to 100° C., and the preform was stretch blow molded for 1 second in the mold at a blow pressure from 5 to 40 kg/cm² to produce an in-mold labeled stretch blow molded product.

The obtained labeled molded product was a container having a rectangular body 12 cm high and approximately 7 cm on a side. The label adhesion strength of the obtained labeled molded product is shown in Table 1.

### Working Example 2

An in-mold label for stretch blow molding and an in-mold labeled stretch blow molded product were obtained in the same manner as Working Example 1 except that the laminate resin film obtained in Production Example 2 was used as the substrate layer (I), and a heat sealable resin layer (II) was provided on the surface of the layer (e) side of the film. The label adhesion strength of the obtained labeled molded product is shown in Table 1.

### Working Example 3

An in-mold label for stretch blow molding and an in-mold labeled stretch blow molded product were obtained in the same manner as Working Example 1 except that the laminate resin film obtained in Production Example 3 was used as the substrate layer (I), and a heat sealable resin layer (II) was provided on the surface of the layer (g) side of the film. The label adhesion strength of the obtained labeled molded product is shown in Table 1.

### Working Example 4

An in-mold label for stretch blow molding and an in-mold labeled stretch blow molded product were obtained in the same manner as Working Example 1 except that the laminate resin film obtained in Production Example 4 was used as the substrate layer (I), and a heat sealable resin layer (II) was provided on the surface of the corona discharge treated side of the film. The label adhesion strength of the obtained labeled molded product is shown in Table 1.

### Working Example 5

An in-mold label for stretch blow molding and an in-mold labeled stretch blow molded product were obtained in the same manner as Working Example 1 except that an emulsion solution of ethylene-vinylacetate copolymer (trade name LIFE BOND HCN-006, produced by Nichiei Kako Co., Ltd.; solid concentration 50%) was used as the coating solution containing an ethylene-based copolymer. The label adhesion strength of the obtained labeled molded product is shown in Table 1.

### Working Example 6

An in-mold label for stretch blow molding and an in-mold labeled stretch blow molded product were obtained in the same manner as Working Example 1 except that a hot lacquer of ethylene-vinylacetate copolymer (trade name Tomoflex THS-4884-U, produced by Toyo-Morton, Ltd.; solid concentration 15%) was used as the coating solution containing an ethylene-based copolymer. The label adhesion strength of the obtained labeled molded product is shown in Table 1.

### Working Example 7

An in-mold label for stretch blow molding and an in-mold labeled stretch blow molded product were obtained in the same manner as Working Example 1 except that an emulsion solution of ethylene-methacrylic acid-acrylic acid alkyl ester copolymer was used as the coating solution containing an ethylene-based copolymer. The label adhesion strength of the obtained labeled molded product is shown in Table 1. The emulsion solution of ethylene-methacrylic acid-acrylic acid alkyl ester copolymer was produced according to the following procedure.

### Production Example of Coating Solution Containing Olefin-Based Resin

40 kg of isopropanol (trade name Tokuso IPA, produced by Tokuyama Corp.) was put in a reactor of interior volume 150 L equipped with a cooler, nitrogen introduction pipe, stirrer, monomer dropping funnel, and heating jacket.

While the isopropanol was stirred, 12.6 kg of N,N-dimethylamino ethyl methacrylate (trade name Methacrylate DMA, produced by Sanyo Chemical Industries, Ltd.), 12.6 kg of butyl methacrylate (trade name Acryester B, produced by Mitsubishi Rayon Co., Ltd.), and 2.8 kg of higher alcohol methacrylic acid ester (trade name Acryester SL, mixture of lauryl methacrylate and tridecyl methacrylate, produced by Mitsubishi Rayon Co., Ltd.) were put in the reactor.

The gas inside the reactor was replaced with nitrogen, and the mixture in the reactor was heated to 80° C. 0.3 kg of azobisisobutyronitrile (trade name V-60 (AIBN), produced by Wako Pure Chemical Industries, Ltd.) was added as a polymerization initiator to the heated mixture, and polymerization was initiated. The polymerization time was 4 hours. The reaction temperature was maintained at 80° C. during polymerization.

After that, the copolymer obtained by polymerization was neutralized using 4.3 kg of glacial acetic acid (produced by Wako Pure Chemical Industries, Ltd.). Additionally, while isopropanol was distilled out, 48.3 kg of ion exchange water was added to the reactor to replace the solvent, and an aqueous solution of neutral product of cationic polymeric emulsifier containing (meth)acrylic-based copolymer was thereby obtained.

The aqueous solution obtained by the above procedure was used as a dispersion to be described later. The solid concentration in the dispersion was 35% by mass. The weight-average molecular weight of the (meth)acrylic-based copolymer was 40,000.

Next, the olefin-based resin was melt-kneaded and emulsified using a twin-screw extruder (TEX3OHSS, produced by Japan Steel Works, Ltd.), thereby producing a coating solution containing olefin-based resin. Melt-kneading and emulsification of the olefin-based resin were performed according to the following procedure.

First, pellets of olefin-based resin were supplied from a hopper to a twin-screw extruder. As the olefin-based resin, ethylene-methacrylic acid-acrylic acid ester copolymer resin (trade name Nucrel N035C, produced by DuPont-Mitsui Polychemicals Co., Ltd.) was used.

The resin was melted and kneaded in a twin-screw extruder at a screw rotation rate of 300 rpm and a cylinder temperature of 160 to 250° C. Then, the above dispersion was supplied from an inlet provided in the middle portion of the cylinder of the twin-screw extruder. The added amount of the dispersion, in terms of solids in the dispersion, was 15 parts by mass per 100 parts by mass of olefin-based resin. Emulsification and dispersion of the olefin-based resin proceeded in the twin-screw extruder, and a white olefin-based copolymer emulsion solution was obtained from the outlet of the twin-screw extruder.

The solid concentration of the emulsion solution was 45% by mass, and the volume-average particle size of the emulsion was 0.7 μm.

### Comparative Example 1

An in-mold label for stretch blow molding and an in-mold labeled stretch blow molded product were obtained in the same manner as Working Example 1 except that an emulsion solution of modified styrene-based copolymer (trade name Baron BL-1, produced by Daiichi Toryo Manufacturing, Ltd.; solid concentration 42.8%) was used instead of the coating solution containing an ethylene-based copolymer. The label adhesion strength of the obtained labeled molded product is shown in Table 1.

### Evaluation

Evaluation of the laminate resin films in the production examples and the labeled blow molded products in the working examples and comparative examples was performed by the following methods.

### (1) Label Adhesion Strength

The in-mold labels obtained in the working examples and comparative examples were each punched into rectangles measuring 8 cm on the long edge by 6 cm on the short edge, and labels for producing labeled molded products were prepared.

Each of the above labels was charged using an electrostatic charger, and placed in a molding die of a stretch blow molder (trade name ASB-70DPH, produced by Nissei ASB Machine Co., Ltd.) such that the opposite surface of the heat sealable resin layer (II) abutted on the mold (such that the heat sealable resin layer (II) faced toward the cavity side). Each label was placed in the mold such that the long edge of the label would adhere parallel to the circumferential direction of the body of the molded product.

The mold was cooled such that the surface temperature on the cavity side was in the range from 20 to 45° C.

Then, a polyethylene terephthalate preform was preheated to 100° C., and the preform was stretch blow molded for 1 second in the mold at a blow pressure from 5 to 40 kg/cm² to produce an in-mold labeled stretch blow molded product.

The obtained labeled molded product was a container having a rectangular body 12 cm high and approximately 7 cm on a side.

The obtained labeled molded product was stored for 2 days in an environment at temperature 23° C. and relative humidity 50%, and then the label adhered portion was cut out with a cutter, and six measurement samples 12 cm long (the label adhered portion being 9 cm, and the non-adhered portion being 3 cm) and 1.5 cm wide (the label being adhered across the entire width), with the circumferential direction of the container body as the long edge, were taken from two containers.

Then, the label was carefully peeled from the holding (non-adhered) portion, and a PET film (50 μm) with the same width was adhered to the label using an adhesive when the label was peeled off by approximately 1 cm. This was used as a holding portion of the label and a sample for adhesion strength measurement was prepared.

Then, 180-degree peeling was performed using a tensile tester (produced by Shimadzu Corp.) according to JIS K6854-2:1999, and the average value of peel strength from a peel length of 25 mm to 75 mm was measured. The measured values for six samples were averaged, and this was taken as the adhesion strength.

The label adhesion strength is preferably not less than 100 gf/15 mm, more preferably not less than 200 gf/15 mm, even more preferably not less than 300 gf/15 mm, and yet more preferably not less than 400 gf/15 mm. When the label adhesion strength is not less than 100 gf/15 mm, there are almost no problems in practical use.

Furthermore, for the labeled molded product of Comparative Example 2, adhesion was so poor that nearly the entire portion of the label lifted from the container ended up peeling when sampled, and as a result, adhesion strength could not be measured at all.

### (2) Thickness, Film Thickness, Density

The thickness of the in-mold label for stretch blow molding of the present invention was measured using a Constant Pressured Thickness Measurement Instrument (trade name PG-01J, produced by Teclock Corp.) according to JIS K-7130. The thickness and film thickness of each of the layers were determined as follows: samples for cross-section observation were created by cooling measurement samples to a temperature not greater than −60° C. using liquid nitrogen and then placing them on a glass sheet, and cutting at a perpendicular using a razor blade (trade name Proline Blade, produced by Schick Japan Co., Ltd.). The obtained samples were observed at the cross-section using a scanning electron microscope (trade name JSM-6490, produced by JEOL, Ltd.) and the boundary lines between the coating film and each thermoplastic resin composition were distinguished by structural appearance, and the thickness of the entire label and the observed layer thickness ratio were calculated.

TABLE 1

| | In-mold label | | Evaluation |
|---|---|---|---|
| | Laminate resin | | Results |
| | film comprising | | Label adhesion |
| | substrate layer | Heat | strength |
| | (I) | sealable resin layer (II) | (gf/15 mm) |
| Working | Production | Maleic acid-modified | 690 |
| Example 1 | Example 1 | ethylene-vinylacetate | |
| | | copolymer | |
| Working | Production | Maleic acid-modified | 500 |
| Example 2 | Example 2 | ethylene-vinylacetate | |
| | | copolymer | |
| Working | Production | Maleic acid-modified | 360 |
| Example 3 | Example 3 | ethylene-vinylacetate | |
| | | copolymer | |
| Working | Production | Maleic acid-modified | 650 |
| Example 4 | Example 4 | ethylene-vinylacetate | |
| | | copolymer | |
| Working | Production | Ethylene-vinylacetate | 240 |
| Example 5 | Example 1 | copolymer | |
| Working | Production | Ethylene-vinylacetate | 360 |
| Example 6 | Example 1 | copolymer | |
| Working | Production | Ethylene-methacrylic | 110 |
| Example 7 | Example 1 | acid-acrylic acid ester | |
| | | copolymer | |
| Comparative | Production | Modified styrene- | 10 |
| example 1 | Example 1 | based copolymer | |

### INDUSTRIAL APPLICABILITY

According to the in-mold label for stretch blow molding of the present invention, a molded product having sufficient adhesion strength with a molded product can be obtained even under low-temperature adhesion conditions by stretch blow molding.

### REFERENCE NUMBER

1: In-mold label for stretch blow molding
2: Substrate layer (I)
3: Heat sealable resin layer (II)
4: Stretched film of resin composition containing a thermoplastic resin and a hydrophilically treated inorganic fine powder
5: Printable layer (III)

1. An in-mold label for stretch blow molding, the in-mold label comprising:
a substrate layer (I); and
a heat sealable resin layer (II);
the substrate layer (I) comprising a resin composition containing a thermoplastic resin and an inorganic fine powder;
the heat sealable resin layer (II) comprising a coating layer formed by applying a coating solution containing an ethylene-based copolymer on the substrate layer (I) and drying.

2. The in-mold label for stretch blow molding according to claim 1, wherein a liquid absorption coefficient of a surface of the substrate layer (I) on a side of the heat sealable resin layer (II) is not greater than 4 mL/m² (ms)^{1/2}.

3. The in-mold label for stretch blow molding according to claim 1, wherein the thermoplastic resin contains a polypropylene-based resin.

4. The in-mold label for stretch blow molding according to claim 1, wherein the substrate layer (I) comprises a non-stretched film of a resin composition.

5. The in-mold label for stretch blow molding according to claim 1, wherein the substrate layer (I) comprises a stretched film of a resin composition that is at least uniaxially stretched.

6. The in-mold label for stretch blow molding according to claim 5, wherein the substrate layer (I) comprises a stretched film in which a resin composition containing a thermoplastic resin and a hydrophilically treated inorganic fine powder is stretched at least uniaxially stretched.

7. The in-mold label for stretch blow molding according to claim 1, wherein the ethylene-based copolymer is an ethylene-vinylacetate copolymer.

8. The in-mold label for stretch blow molding according to claim 7, wherein the ethylene-vinylacetate copolymer is a maleic acid-modified ethylene-vinylacetate copolymer.

9. The in-mold label for stretch blow molding according to claim 1, wherein the coating solution containing an ethylene-based copolymer comprises an emulsion in which an ethylene-based copolymer is dispersed in an aqueous medium.

10. The in-mold label for stretch blow molding according to claim 9, wherein an average particle size of the emulsion of ethylene-based copolymer is from 0.01 to 3 μm.

11. The in-mold label for stretch blow molding according to claim 6, wherein the heat sealable resin layer (II) is a coating layer formed by drying in a state in which some of the coating solution containing an ethylene-based copolymer is absorbed on the stretched film.

12. The in-mold label for stretch blow molding according to claim 1, wherein a printable layer (III) is further provided on a surface of the substrate layer (I).

13. An in-mold labeled stretch blow molded product to which the in-mold label for stretch blow molding described in claim 1 is adhered, an adhesion strength of the label on the molded product being from 100 to 1000 g/15 mm.

14. The in-mold labeled stretch blow molded product according to claim 13, wherein the resin that forms the stretch blow molded product comprises at least one of polyester-based resins, polycarbonate-based resins, polystyrene-based resins, polypropylene-based resins, and polyethylene-based resins.
